(19) United States
(12) Patent Application Publication
(10) Pub. No.: US 2008/0068460 A1
(43) Pub. Date: Mar. 20, 2008

(54) Covert camera system having multiple configurations

(76) Inventors: Wesley Sheridan, Chalfont, PA (US); Jules Olita, Warrington, PA (US); Owen Medd, Newtown, PA (US)

Correspondence Address: Armand M. Vozzo, Jr., Esquire, 19 Short Road, Doylestown, PA, 18901, US

(21) Appl. No.: 11/804,617

(22) Filed: May 18, 2007

Related U.S. Application Data
(60) Provisional application No. 60/801,960, filed on May 20, 2006.

(51) Int. Cl. H04N 7/18

(52) U.S. Cl. 348/143; 348/E07.085

(57) ABSTRACT

An improved camera system is disclosed having multiple operating configurations useful for conducting covert surveillance. The covert camera system comprises separate camera and display units with associated housings containing respective image sensing and viewing means operatively connected by an electrical cable and movable relative to each other upon an articulated extension arm adapted to carry the cable therethrough and between the respective housings. The articulated extension arm includes a plurality of longitudinal arm segments each similarly channeled in form with successive arm segments being interconnected by a rotating friction hinge assembly that further routes the cable and allows each successive arm segment to rotate 180° relative to the other. The cable is centrally routed through a pocket member attached along the extension arm, the pocket being formed having a chamber that accommodates the cable length during rotational movement of the arm segments. Opposite ends of the extension arm are rotatably connected to the separate camera and display housings via respective joint assemblies that permit the respective housings to be selectively turned in different orientations while maintaining the cable connection therebetween. The present camera system is capable of being deployed from a compact stowed configuration to a multitude of hand-held and tripod-mounted operating configurations.

### CROSS-REFERENCE TO RELATED APPLICATION

This application is a continuation-in-part of Provisional Application Ser. No. 60/801,960 filed May 20, 2006 for Covert Camera System Having Multiple Configurations.

### BACKGROUND OF THE INVENTION

The present invention relates to camera systems generally used in search and surveillance operations conducted by military, law enforcement and security personnel as well as by emergency responders, and more particularly to an improved covert camera system having an articulated extension arm disposed between separate display and camera housings and further rotatably coupled thereto to provide multiple operating configurations and a compact stowed configuration for the user.

In the conduct of search and surveillance, particularly conducted by the military in field reconnaissance operations conducted by combat soldiers using portable, hand-held cameras, the need for covert observation is paramount. To escape detection and avoid threat of snipers, it is important that reconnaissance personnel make observations from behind barriers while maintaining a wide range of view of the targeted area to accurately assess all threats. The failure to do so, either by exposing the reconnaissance observer or by restricting his range of view, can result in loss of life and risk the overall success of the military operations. Similar concerns with maintaining covert reconnaissance also arise in non-military security operations, such as in police enforcement activities, where serious threats to the life of personnel often exist.

Currently, there are a variety of portable, hand-held cameras used in military and police operations that employ various thermal imaging technologies to observe and identify threats in a targeted area. None of these cameras, however, are capable of effective covert use and generally require the combat soldier to expose himself to view and to the threat of injury in order to observe the area. Accordingly, there is a recognized need for a portable, hand-held camera system that can be used covertly by military and non-military personnel in reconnaissance operations and make effective observations from behind protective barriers without limiting the field of view of the user.

### SUMMARY OF THE INVENTION

Accordingly, it is a general purpose and object of the present invention to provide an improved portable imaging system that can be used covertly by military and non-military security personnel in reconnaissance operations.

A more particular object of the present invention is to provide a portable and compact camera system that can be hand-held or mounted on a tripod by reconnaissance personnel to allow surveillance of a particular area from behind a protective barrier.

Another object of the present invention is to provide a covert reconnaissance camera system that can be easily carried and readily deployed by personnel in a variety of operating configurations adaptable to the particular reconnaissance site and targeted area of observation.

Still another object of the present invention is to provide a compact and lightweight yet rugged imaging system for covert reconnaissance that is easily stowed upon personnel and easily deployed for use.

A still further object of the present invention is to provide a multi-mode camera system having both video and infrared capabilities for covert reconnaissance that is capable of observing a wide range of the targeted area of observation without exposing the user to threats in the area.

Briefly, these and other objects of the present invention are accomplished by an improved camera system useful for conducting covert surveillance, the system comprising separate camera and display units with associated housings containing respective image sensing and viewing means operatively connected by an electrical cable and movable relative to each other upon an articulated extension arm adapted to carry the cable therethrough and between the respective housings. The articulated extension arm includes a plurality of longitudinal arm segments each similarly channeled in form with successive arm segments being interconnected by a rotating friction hinge assembly that further routes the cable and allows each successive arm segment to rotate 180° relative to the other. The cable is centrally routed through a pocket member attached along the extension arm, the pocket being formed having a chamber that accommodates the cable length during rotational movement of the arm segments. Opposite ends of the extension arm are rotatably connected to the separate camera and display housings via respective joint assemblies that permit the respective housings to be selectively turned in different orientations while maintaining the cable connection therebetween. The camera system contains both high-resolution infrared and low-light level video capabilities and is further capable of being deployed from a compact stowed configuration to a multitude of hand-held and tripod-mounted operating configurations.

For a better understanding of these and other aspects of the present invention, reference should be made to the following detailed description taken in conjunction with the accompanying drawings in which like reference numerals and characters designate like parts throughout the figures thereof.

### BRIEF DESCRIPTION OF THE DRAWINGS

For a fuller understanding of the nature and object of the present invention, references in the detailed description of the preferred embodiment set forth below shall be made to the accompanying drawings in which:

FIG. 1 is a side perspective view of the covert camera system of the present invention folded in a stowed configuration;

FIG. 2 is further perspective view of the camera system in its stowed configuration taken from the opposite side of that shown in FIG. 1;

FIG. 3 is a side elevation view of the present camera system shown in an initially deployed configuration from that of FIGS. 1 and 2;

FIG. 4 is a side elevation view of the present camera system in a fully extended deployed configuration;

FIG. 5 is a perspective view of a portion of the articulated extension arm of the deployed camera system of FIG. 4 further showing the hinge connector assembly between successive arm segments;

FIG. 6 is a side elevation view of the central portion of the articulated extension arm further showing the cable pocket disposed thereon;

FIG. 7 is a side elevation view of the rotatable interface connection between the articulated extension arm and the display unit housing of the present invention;

FIG. 8 is a side perspective view of the rotatable interface connection between the articulated extension arm and the camera unit housing of the present invention;

FIG. 9 is an exploded view of the rotatable interface connection shown in FIG. 8;

FIG. 10 is an exploded view of the hinge connector assembly shown in FIG. 5;

FIGS. 11A and 11B are respective depictions of the present covert camera system for hand-held deployments to provide direct and indirect view over a barrier; and

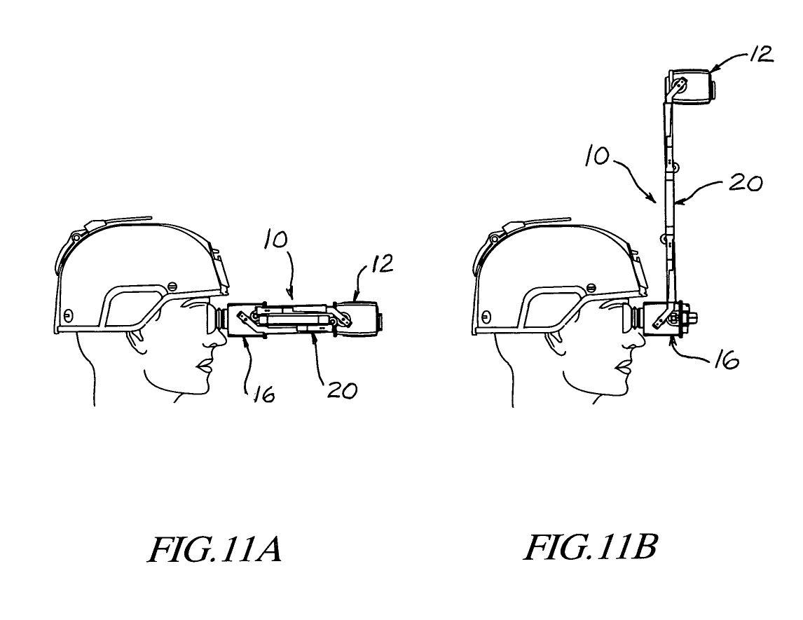

FIGS. 12A and 12B are respective depictions of the present covert camera system for tripod-mounted deployments to provide direct and indirect view over a barrier.

### DETAILED DESCRIPTION OF THE INVENTION

The following is a detailed description of a preferred embodiment of the present invention and the best presently contemplated mode of its production and practice. This description is further made for the purpose of illustrating the general principles of the invention but should not be taken in a limiting sense, the scope of the invention being best determined by reference to appended claims.

Referring now to the drawings, the improved camera system of the present invention, generally designated 10, comprises a camera unit 12 and separate display unit 16, each having an associated housing, a camera unit housing 14 and display unit housing 18. Packaged and contained in their respective housings 14 and 18, both the camera unit 12 and the display unit 16 are lightweight and sized to be held and manipulated by hand and further made rugged and durable for use and protection in various environments and field conditions. The camera unit 12 and its front end sensor means 30 incorporates current state-of-the-art optics and image-sensing technologies capable of producing both high resolution thermal images, typically 320×240 resolution using infrared (IR) microbolometer technology, and low-light level video images thereby providing the user with both nighttime and daylight capabilities. The display unit 16 further incorporates state-of-the-art electronics and optical means for displaying the high resolution images to the user, those images being capable of view by the user through a conventional eye piece member 28. The combination of camera unit 12 and display unit 16 together consume minimal electrical power, typically less than two watts, and can be powered by conventional DC batteries, typically AA in size, a set of which will power the camera system 10 continuously for hours.

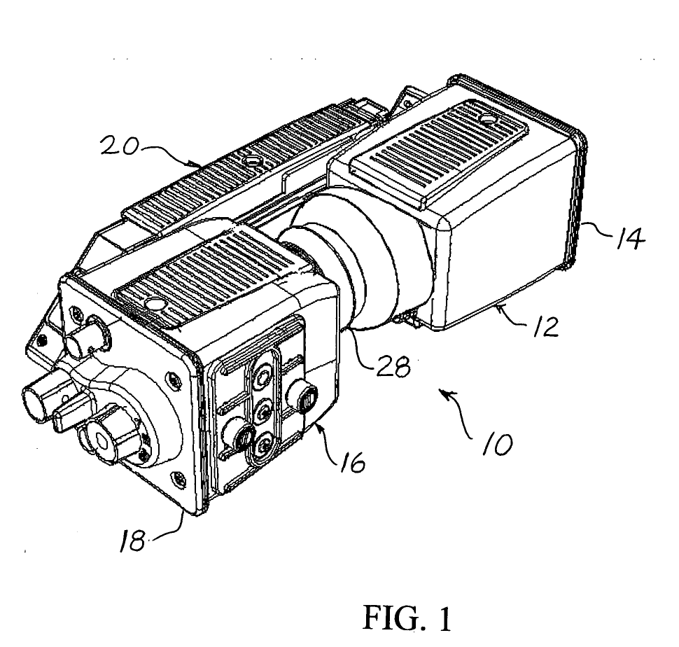

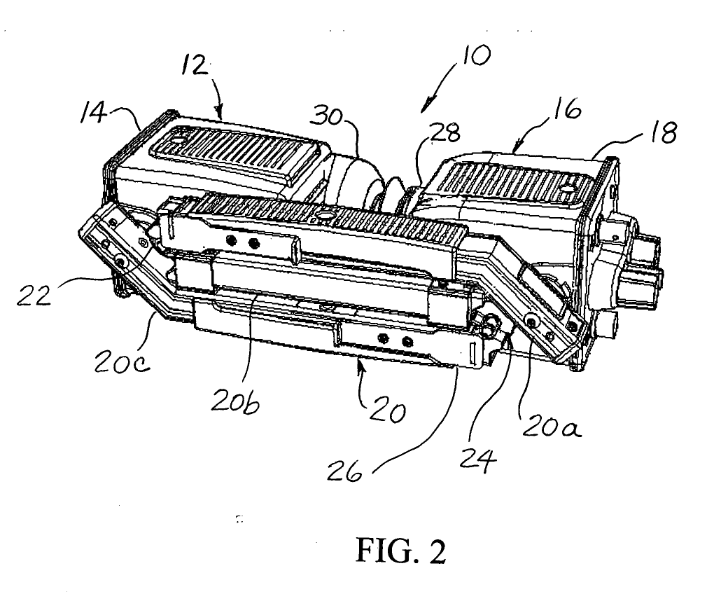

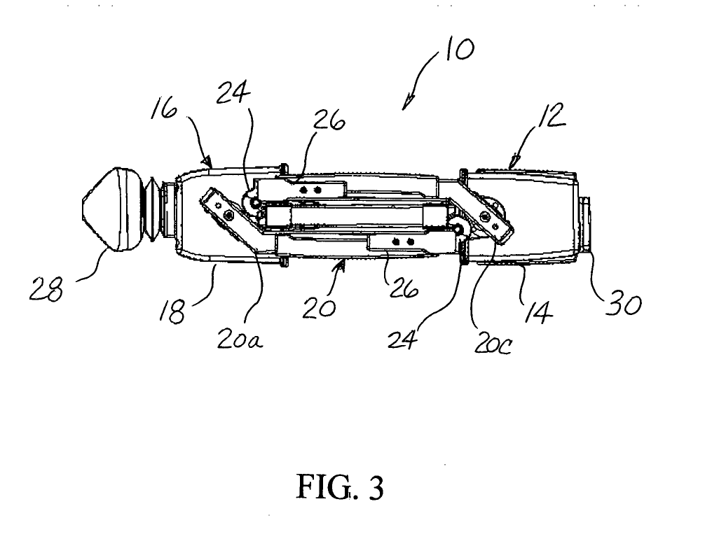

The camera unit 12 and display unit 16 are operatively connected by an articulated extension arm 20 that is rotatably joined to the units at opposite ends thereof and further by an electrical cable 22 routed between the respective units and through the extension arm. The extension arm 20 is “articulated” in the sense that it is made of multiple parts united together by one or more flexible joints. In the case of the present camera system 10, the articulated extension arm 20 comprises a series of three longitudinal arm segments 20a, 20b, and 20c flexibly coupled by a pair of intermediate rotating hinge assemblies 24. Each of the arm segments of the articulated extension arm 20 are similarly constructed in a rigid and substantially closed channel form, the middle arm segment 20b being substantially straight in its length while the outer arm segments 20a and 20c are angled and inclined over a portion of their respective opposite ends for suitable interfacing with the camera unit housing 14 and the display unit housing 18 to provide a compact and streamlined profile to the camera system 10 both in its stowed configuration, as seen in FIGS. 1 and 2, and in its direct view deployment, as seen in FIG. 3.

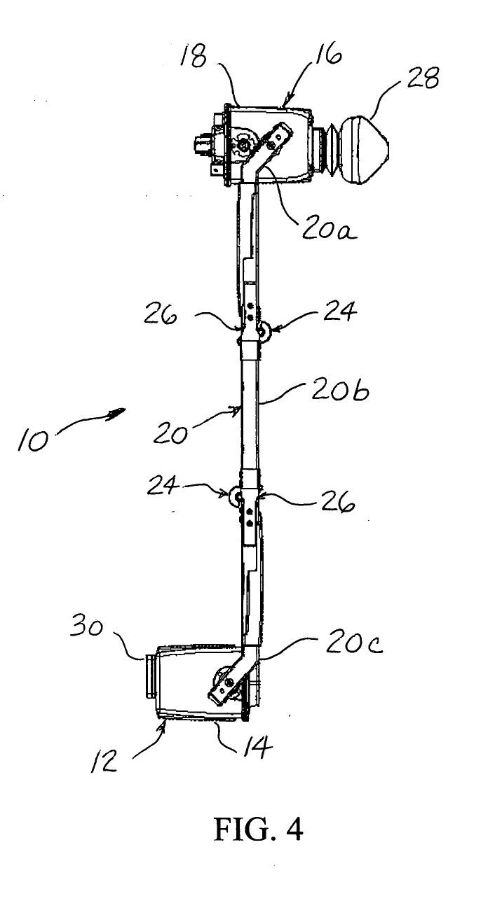

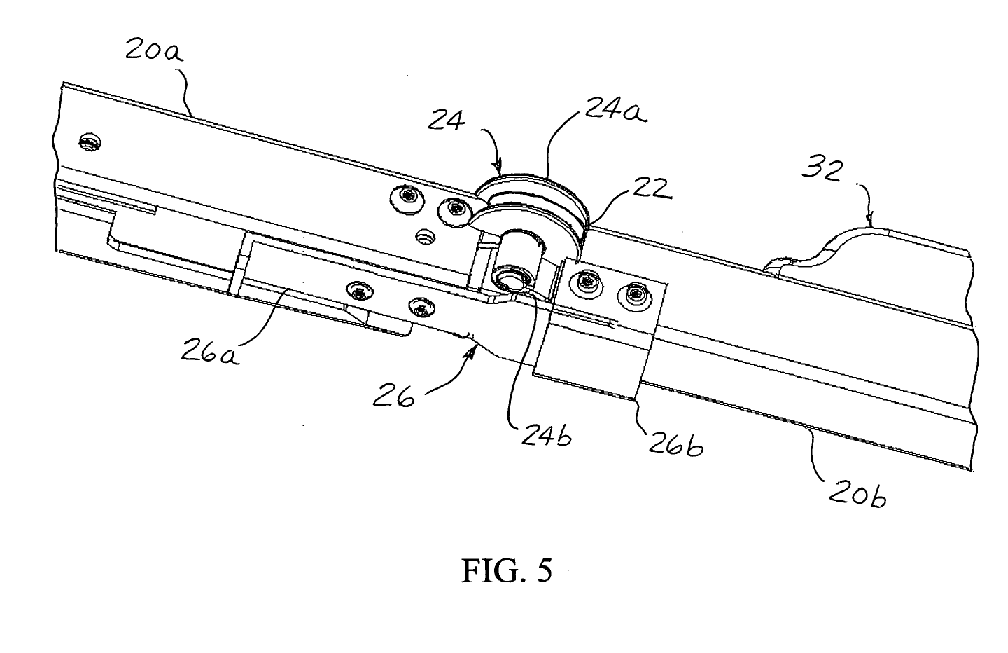

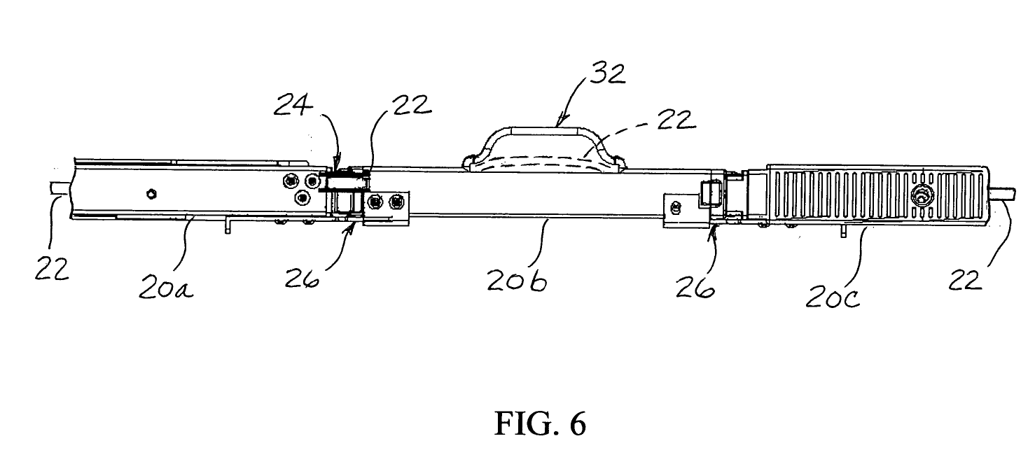

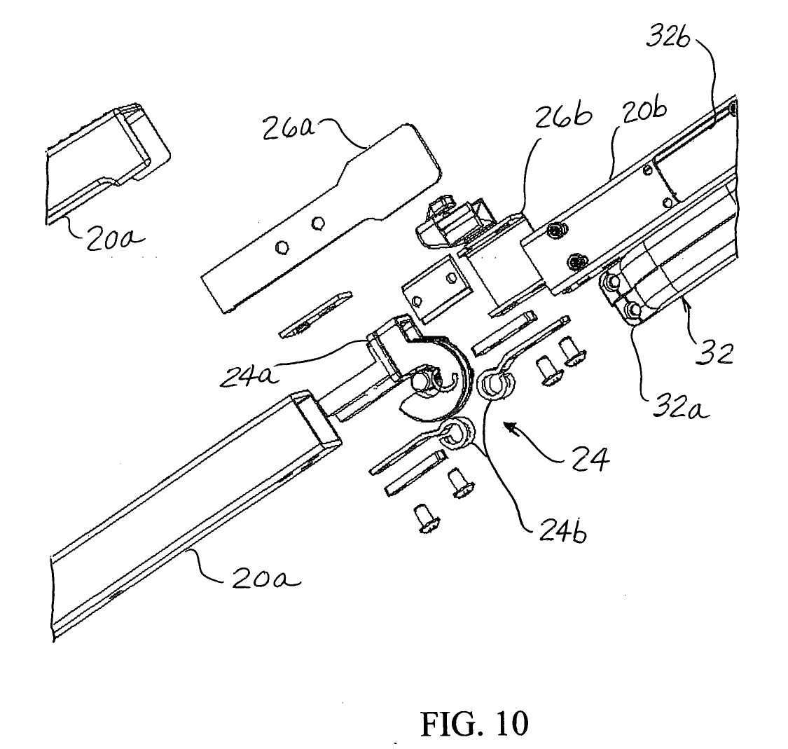

The hinge assembly 24 disposed and connected between successive arm segments 20a, 20b and 20c is a specially adapted version of a rotating friction hinge, such as that currently used on laptop computers, that is made spool-like in form and tensioned to provide flexible routing of the electrical cable through the articulated extension arm 20 during all phases of deployment of the camera system 10. More closely viewed in FIGS. 5 and 10, each hinge assembly 24 is comprised of a spool-like member 24a for bearing the routed cable 22 between successive arm segments 20a, 20b and 20c and spring elements 24b that provide hinge tensioning. A pair of locking clip assemblies 26 are disposed and mounted along the side of the articulated extension arm 20, specifically at the junction of the successive arm segments 20a, 20b and 20c adjacent to a respective one of the hinge assemblies 24 to maintain the arm segments together in an extended disposition either in pairs or in a complete extended deployment, as shown in FIG. 4. More closely viewed in FIGS. 5 and 10, each locking clip assembly 26 is comprised of a clip member 26a that is slidingly connected along the side of each of the outer arm segments 20a and 20c near the end thereof proximate to its junction with the middle arm segment 20b and further comprises a catch member 26b adapted to mount in fixed attachment to the middle arm segments at each end thereof and formed to fit the end of the clip member upon sliding engagement therewith. A cable pocket 32 comprising a pocket enclosure 32a formed having a specially adapted chamber is mounted and attached to the middle arm segment 20b along one side thereof. Best viewed in FIGS. 6 and 10, the cable pocket 32 is disposed at the approximate center of the articulated extension arm 20 and is vented to the interior thereof through a rectangular slot 32b formed centrally in the adjoining side of the middle arm segment 20b. The cable pocket 32 is designed and serves to accommodate a certain length of the electrical cable 22 during extended deployment of the articulated extension arm 20.

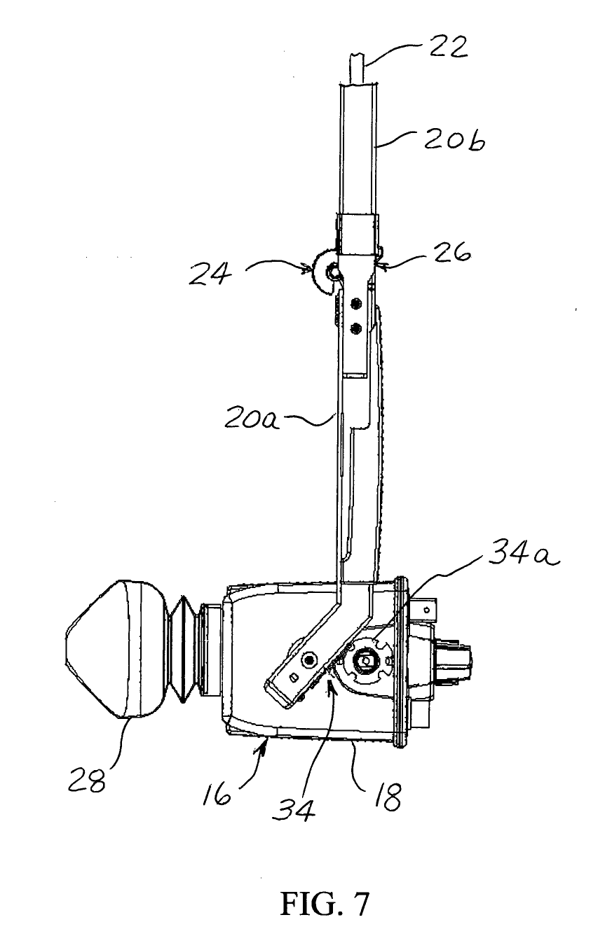

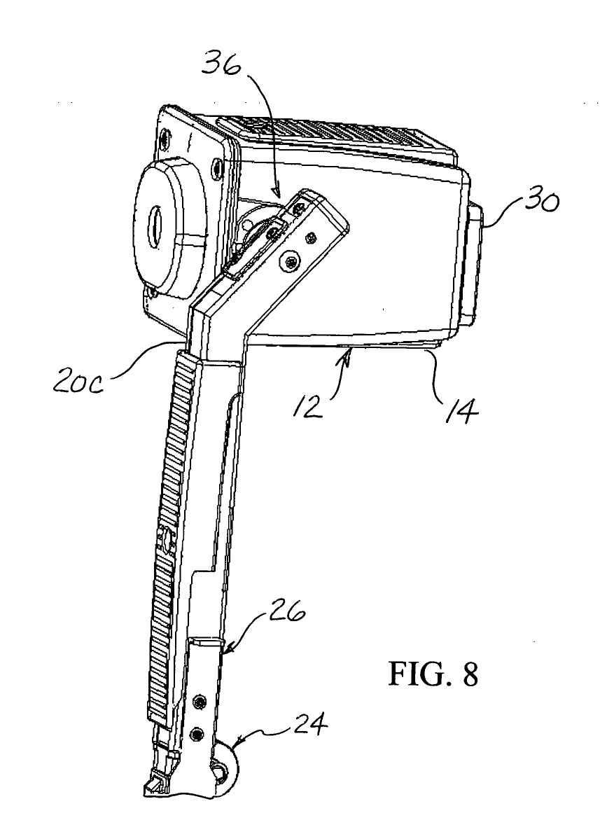

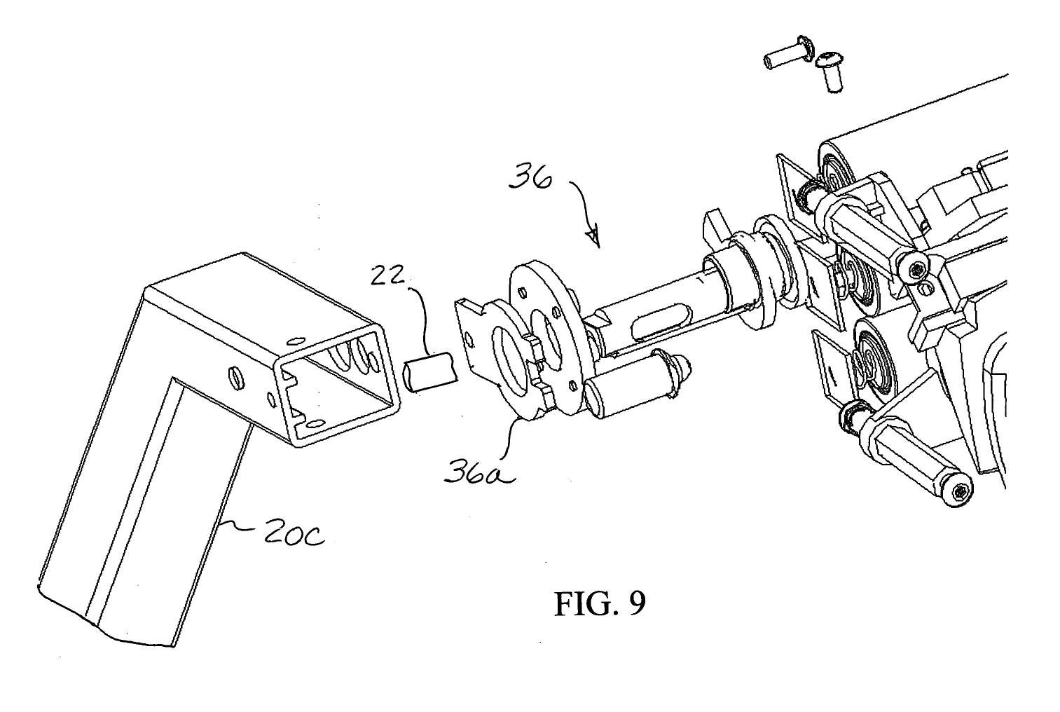

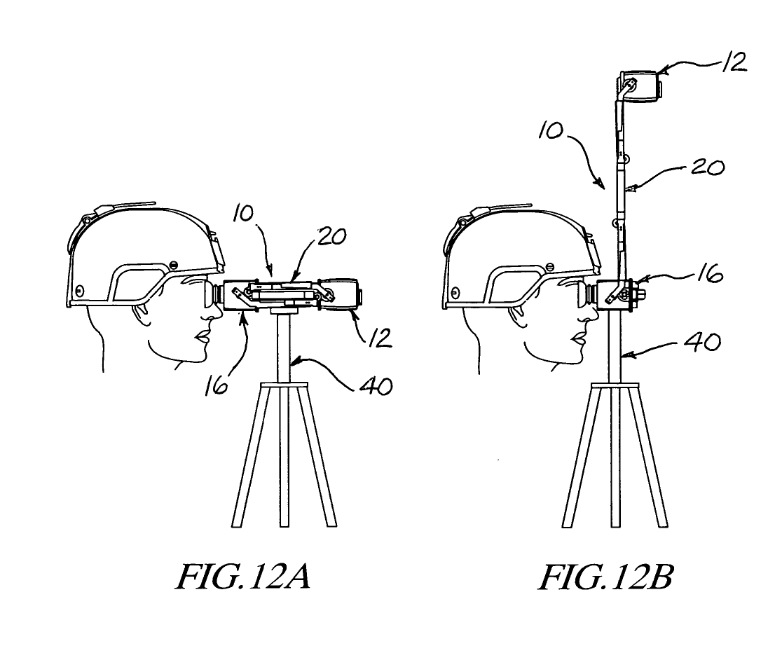

Opposite ends of the articulated extension arm 20 are rotatably connected to the camera unit 12 and display unit 16 and their respective housings 14 and 18, respectively, with the cable 22 being maintained in its electrical connection with both units during their full extent of rotation. As best viewed in FIG. 7, a first rotating joint interface 34 is assembled between the extended and angled end of outer arm segment 20a and the display unit housing 18 and includes a rotating cam member 34a for providing a staged 270° rotation of the display unit 16. As best viewed in FIGS. 8 and 9, a second rotating joint interface assembly 36 is assembled between the extended and angled end of outer arm segment 20c and the camera unit housing 14 and comprises an axial group of elements including a rotating cam member 36a that allows coaxial passage of the electrical cable 22 from the outer arm segment through the camera housing and into the camera unit 12 while providing 180° of staged rotation thereto. The combination of these capabilities for effective rotational movements of both the camera unit 12 and the display unit 16 deployed upon the articulated extension arm 20 permits a multitude of operating modes and configurations available to the user of the present camera system 10. With the ability to mount the camera system 10 upon a tripod 40, as shown in FIGS. 12A and 12B, those operating modes and configurations are as follows: prone hand-held (direct view) IR; prone tripod IR; prone tripod video; periscope hand-held IR in three different height configurations of the articulated extension arm 20 (short, partial and fully extended); periscope hand-held video in three different height configurations; periscope tripod IR in three different height configurations; periscope tripod IR; probe IR; probe video; around corner IR; and around corner/over barrier (indirect view) IR; and around corner/over barrier video.

Therefore, it is apparent that the described invention provides an improved portable camera system that can be used covertly by military and non-military security personnel in reconnaissance operations to effectively survey a targeted area of concern without exposing the user-viewer to hostile threats in the area. More particularly, the disclosed invention provides a portable and compact camera system that can be hand-held or mounted on a tripod by reconnaissance personnel to allow surveillance of a particular area in a covert fashion from behind a protective barrier. The present invention further provides a covert reconnaissance camera system with both high resolution video and infrared capabilities that can be easily carried and readily deployed by personnel in a variety of operating configurations adaptable to the particular reconnaissance site and targeted area of observation. The disclosed camera system of the present invention is housed and assembled to provide a compact and lightweight yet rugged device that is well suited for covert surveillance and easily stowed and carried upon personnel. In addition, the described invention provides a high-resolution thermal imaging camera system that is capable of observing a wide range of threats in a targeted area of observation without exposing the viewer to detection and possible injury.

Obviously, other embodiments and modifications of the present invention will readily come to those of ordinary skill in the art having the benefit of the teachings presented in the foregoing description and drawings. Alternate embodiments of different shapes and sizes, as well as substitution of known materials or those materials which may be developed at a future time to perform the same function as the present described embodiment are therefore considered to be part of the present invention. Accordingly, it is understood that this invention is not limited to the particular embodiment described, but rather is intended to cover modifications within the spirit and scope of the present invention as may be expressed in appended claims.

What is claimed:

1. A camera system for conducting surveillance of a subject area, comprising:
camera means assembled and housed for producing images of the subject area;
display means assembled and housed separate from said camera means and operatively connected thereto for viewing the images of the subject area; and
articulated extension arm means disposed between said camera means and said display means and rotatably connected to each for deploying said camera means relative to said display means from a folded stowed position into a plurality of extended operating configurations for surveillance.

2. A camera system according to claim 1, wherein said articulated extension arm means comprises:
an extension arm member having opposite ends thereof rotatably connected to each of said camera means and said display means, said extension arm member being articulated in the construction and assembly thereof so that said arm member may be folded and extended into a plurality of configurations between said camera means and said display means.

3. A camera system according to claim 2, further comprising:
an electrical cable connected between said camera means and said display means and routed through said articulated extension arm member;
first joint interface means assembled and rotatably coupled between one end of said articulated extension arm member and said display means for providing staged rotation of said display means relative to said extension arm member while maintaining said electrical cable in connection with said display means during rotation thereof; and
second joint interface means assembled and rotatably coupled between the opposite end of said articulated extension arm member and said camera means for providing a staged rotation of said camera means relative to said extension arm member while maintaining said electrical cable in connection with said camera means during rotation thereof.

4. A camera system according to claim 3, wherein:
said first joint interface means comprises a first cam member for providing 270° of staged rotation of said display means relative to said extension arm member; and
said second joint interface means comprises a second cam member for providing 180° of staged rotation of said camera means relative to said extension arm member.

5. A camera system according to claim 3, wherein said articulated extension arm member comprises:
a plurality of arm segments each channeled in form for routing said electrical cable and pivotally connected together in succession;
a plurality of hinge assemblies disposed for rotation and connected between successive arm segments; and
locking clip means disposed and mounted between successive arm segments to maintain said successive arm segments together in an extended position.

6. A camera system according to claim 5, wherein said articulated extension arm member further comprises:
a pocket member mounted and attached along a central one of said arm segments, said pocket member being formed having a chamber connected to accommodate a limited length of said electrical cable from within said arm segments during deployment of said articulated extension arm.

7. A camera system according to claim 5, wherein said hinge assemblies each comprise:
a spool-like member tensioned to provide flexible routing of said electrical cable between successive arm segments of said articulated extension arm member during deployment.

8. A camera system according to claim 5, wherein said locking clip means comprises:
a clip member slidingly disposed along one of said successive arm segments; and
a catch member attached to the proximate other of said successive arm segments and formed to hold said clip member upon sliding engagement therewith.

9. A camera system according to claim 1, wherein said camera means comprises:
a camera unit; and
image sensor means operatively connected to said camera unit for selectively producing infrared and low-light level video images of the subject area.

10. A camera system for conducting covert surveillance of a subject area, comprising:
a camera unit assembled and housed for selectively producing infrared and low-level video images of the subject area;
a display unit assembled and housed separate from said camera unit and electrically connected thereto for viewing the images selectively produced of the subject area;
a cable member for electrically connecting said camera unit to said display unit; and
articulated means disposed between said camera unit and said display unit and rotatably connected to each for deploying said camera unit relative to said display unit from a folded stowed position into a plurality of extended operating configurations while carrying said electrical cable.

11. A camera system according to claim 10, wherein said articulated means comprises:
an extension arm member having opposite ends thereof rotatably connected to each of said camera and display units, said extension arm member being articulated in the construction and assembly thereof so that said arm member may be folded and extended into a plurality of configurations between said camera unit and display unit.

12. A camera system according to claim 11, further comprising:
first joint interface means assembled and rotatably coupled between one end of said articulated extension arm member and said display unit for providing staged rotation of said display unit relative to said extension arm member while maintaining said cable member in connection with said display unit during rotation thereof; and
second joint interface means assembled and rotatably coupled between the opposite end of said articulated extension arm member and said camera unit for providing a staged rotation of said camera unit relative to said extension arm member while maintaining said cable member in connection with said camera unit during rotation thereof.

13. A camera system according to claim 12, wherein:
said first joint interface means comprises a first cam member for providing 270° of staged rotation of said display unit relative to said extension arm member; and
said second joint interface means comprises a second cam member for providing 180° of staged rotation of said camera unit relative to said extension arm member.

14. A camera system according to claim 11, wherein said articulated extension arm member comprises:
a plurality of arm segments each channeled in form for routing said cable member and pivotally connected together in succession;
a plurality of hinge assemblies disposed for rotation and connected between successive arm segments; and
locking clip means disposed and mounted between successive arm segments to maintain said successive arm segments together in an extended position.

15. A camera system according to claim 14, wherein said articulated extension arm member further comprises:
a pocket member mounted and attached along a central one of said arm segments, said pocket member being formed having a chamber connected to accommodate a limited length of said electrical cable from within said arm segments during deployment of said articulated extension arm.

16. A camera system according to claim 15, wherein said hinge assemblies each comprise:
a spool-like member tensioned to provide flexible routing of said cable member between successive arm segments of said articulated extension arm member during deployment.

17. A camera system according to claim 16, wherein said locking clip means comprises:
a clip member slidingly disposed along one of said successive arm segments; and
a catch member attached to the proximate other of said successive arm segments and formed to hold said clip member upon sliding engagement therewith.
